(19) United States
(12) Patent Application Publication
(10) Pub. No.: US 2026/0038948 A1
(43) Pub. Date: Feb. 5, 2026

(54) BATTERY PACK MOUNTING STRUCTURE, ELECTRIC DEVICE AND METHOD FOR REMOVING BATTERY PACK

(71) Applicant: Positec Power Tools (Suzhou) Co., Ltd, Jiangsu (CN)

(72) Inventors: Lichao GENG, Suzhou (CN); Yu ZHANG, Suzhou (CN)

(21) Appl. No.: 19/355,883

(22) Filed: Oct. 10, 2025

Related U.S. Application Data
(63) Continuation of application No. PCT/CN2024/087757, filed on Apr. 15, 2024.

(30) Foreign Application Priority Data
Apr. 13, 2023 (CN) 202310396850.7

(51) Int. Cl. H01M 50/262; A01D 34/78; A01D 101/00; H01M 50/247; H01M 50/271

(52) U.S. Cl. CPC H01M 50/262; H01M 50/247; H01M 50/271; A01D 34/78; A01D 2101/00; H01M 2220/30

(57) ABSTRACT

A battery pack mounting structure includes a mounting body configured to support a battery pack; a compartment cover movably mounted on the mounting body and configured to cooperate with the mounting body to form an accommodation cavity for accommodating the battery pack, the compartment cover having a first position where the compartment cover cooperates with the mounting body to close the accommodation cavity, and a second position where the compartment cover is opened to allow access to the battery pack; and a locking mechanism configured to lock or unlock the battery pack. The compartment cover is connected to the locking mechanism in a linkage manner. When the compartment cover is in the first position, the locking mechanism locks the battery pack, and movement of the compartment cover from the first position to the second position triggers a position change of the locking mechanism to unlock the battery pack.

### CROSS-REFERENCE TO RELATED APPLICATION

This application is a continuation Application of and claims priority to PCT Application No. PCT/CN2024/087757, filed on Apr. 15, 2024, which claims benefit of and priority to Chinese Patent Application No. 202310396850.7 filed on Apr. 13, 2023, all of which are hereby incorporated by reference in their entirety for all purposes as if fully set forth herein.

### TECHNICAL FIELD

The present disclosure relates to the field of electric device technology, and specifically relates to a battery pack mounting structure, an electric device and a method for removing a battery pack.

### BACKGROUND

In the conventional techniques, electric devices are typically provided with an accommodation cavity for installing a battery pack. For example, in a lawn mower, during a mowing process, to prevent grass clippings and dust from contaminating the battery pack, a compartment cover is usually provided to close the accommodation cavity, thereby enclosing the battery pack in a sealed space.

### SUMMARY

In view of this, the present disclosure provides one aspect of a battery pack mounting structure and an electric device to solve the problem in the conventional techniques that the battery pack removal operation is cumbersome and inconvenient.

The present disclosure provides a battery pack mounting structure, comprising:
a mounting body forming a battery compartment with an opening, the battery compartment being configured to accommodate a battery pack; and
a compartment cover movably mounted on the mounting body, the compartment cover having a first position where the compartment cover cooperates with the mounting body to close the battery compartment, and a second position where the compartment cover opens the battery compartment to allow access to the battery pack; and
a locking mechanism configured to lock or unlock the battery pack, wherein the compartment cover is connected to the locking mechanism in a linkage manner, when the compartment cover is in the first position, the locking mechanism locks the battery pack, and during the process of the compartment cover moving from the first position to the second position, the compartment cover drives the locking mechanism to change position to unlock the battery pack.

In one embodiment, the battery pack mounting structure comprises:
a mounting body configured to support a battery pack; and
a compartment cover movably mounted on the mounting body, and configured to cooperate with the mounting body to form an accommodation cavity for accommodating the battery pack, the compartment cover having a first position where the compartment cover cooperates with the mounting body to close the accommodation cavity, and a second position where the compartment cover is opened to allow access to the battery pack; and
a locking mechanism configured to lock or unlock the battery pack; and
wherein movement of the compartment cover from the first position to the second position is configured to trigger a position change of the locking mechanism to unlock the battery pack.

In one embodiment, the compartment cover is connected to the locking mechanism in a linkage manner, and when the compartment cover moves from the first position to the second position, the compartment cover drives the locking mechanism to change position to unlock the battery pack.

In one embodiment, when the compartment cover is in the first position, the locking mechanism locks the battery pack, and the locking mechanism comprises:
a main locking member having a locking position for locking the battery pack in the accommodation cavity and an unlocking position for releasing the battery pack in the accommodation cavity; and
a linkage assembly connected to the compartment cover and configured to act on the main locking member, wherein when the compartment cover moves from the first position to the second position, the linkage assembly drives the main locking member to move from the locking position to the unlocking position.

In one embodiment, a battery pack mounting structure comprises:
a mounting body configured to support a battery pack; and
a compartment cover movably mounted on the mounting body, and configured to cooperate with the mounting body to form an accommodation cavity for accommodating the battery pack, the compartment cover having a first position where the compartment cover cooperates with the mounting body to close the accommodation cavity, and a second position where the compartment cover is opened to allow access to the battery pack; and
a locking mechanism configured to lock or unlock the battery pack; and
an anti-detachment assembly configured to prevent the battery pack from detaching from an installation position when the battery pack mounting structure is turned from a horizontal state to a vertical state; and
wherein movement of the compartment cover from the first position to the second position is configured to trigger a position change of the locking mechanism to unlock the battery pack.

In one embodiment, the compartment cover is pivotally connected to the mounting body, and configured to rotate around an axis of a pivot shaft to the first position and the second position respectively, and the linkage assembly comprises:
an actuating member connected to the compartment cover to rotate synchronously around the axis of the pivot shaft; and
a moving member abutting against the actuating member and configured to act on the main locking member, wherein when the compartment cover rotates from the first position to the second position, the actuating member pushes against the moving member, and the moving member drives the main locking member to move from the locking position to the unlocking position.

In one embodiment, the actuating member is a pawl or a cam, and the moving member is a push rod; or
the actuating member is a gear, and the moving member is a rack.

In one embodiment, the pivot shaft is connected to the compartment cover to rotate synchronously around an axis of the pivot shaft, and the actuating member is disposed on the pivot shaft.

In one embodiment, the linkage assembly is provided with a guiding portion, the main locking member is connected to the moving member through the guiding portion, the guiding portion is configured to guide the main locking member to move along a preset path, the locking position and the unlocking position are both located on the preset path, the guiding portion comprises a first guiding inclined surface and a second guiding inclined surface abutting against each other, the first guiding inclined surface is disposed on the main locking member, and the second guiding inclined surface is disposed on the moving member.

In one embodiment, the battery pack mounting structure further comprises a reset assembly configured to move the main locking member from the unlocking position to the locking position when the compartment cover changes from the second position to the first position; wherein
the reset assembly comprises:
a base disposed on the mounting body, the main locking member being movably mounted in the base; and
a first elastic member having one end pushing against the base and another end pushing against the main locking member, wherein when the compartment cover moves from the second position to the first position, the main locking member moves from the unlocking position to the locking position under action of the first elastic member.

In one embodiment, the compartment cover comprises a grip portion for an operator to grip and open the compartment cover, and the battery pack mounting structure further comprises an unlocking member configured to trigger the locking mechanism to unlock the battery pack, wherein a distance between the unlocking member and the grip portion is configured to allow the operator to apply an external force to the unlocking member while opening the compartment cover with one hand, so as to achieve opening the compartment cover and unlocking the battery pack with one hand by the operator.

In one embodiment, the locking mechanism comprises:
a main locking member having a locking position for locking the battery pack in the accommodation cavity and an unlocking position for releasing the battery pack in the accommodation cavity; and
a first detection assembly connected to the mounting body and configured to detect the position of the compartment cover; and
a first control portion associated with the main locking member and the first detection assembly, wherein when the first detection assembly detects that the compartment cover moves from the first position to the second position, the first control portion controls the main locking member to move from the locking position to the unlocking position.

In one embodiment, a magnetic attachment component is provided between the compartment cover and the mounting body, and the compartment cover is locked to the mounting body by the magnetic attachment component. Since electric devices typically have a vertical first posture and a horizontal second posture, namely a vertical state and a horizontal state, a user may switch the electric device between the horizontal state and the vertical state during use or transportation. To prevent the battery pack from falling out during the state switching process of the electric device, another aspect of the present disclosure provides an electric device. According to another aspect of the present disclosure, a battery pack mounting structure is also provided, comprising:
a mounting body forming a battery compartment with an opening, the battery compartment being configured to accommodate a battery pack; and a compartment cover movably mounted on the mounting body, the compartment cover having a first position where the compartment cover cooperates with the mounting body to close the battery compartment, and a second position where the battery compartment is opened to allow access to the battery pack;
a locking mechanism configured to lock or release the battery pack; and
an anti-detachment assembly, wherein when the locking mechanism releases the battery pack and the battery pack mounting structure is in a first posture where the opening of the battery compartment faces downward, the anti-detachment assembly is configured to prevent the battery pack from detaching through the opening.

In one embodiment, the electric device comprises a device body and the above-mentioned battery pack mounting structure mounted on the device body.

The electric device comprises a battery pack mounting structure, wherein the electric device has a horizontal state and a vertical state, and the battery pack mounting structure comprises:
a mounting body configured to support a battery pack; and
a locking mechanism configured to lock the battery pack to maintain the battery pack at an installation position or release the battery pack to allow the battery pack to detach from the installation position; and
an anti-detachment assembly configured to prevent the battery pack from detaching from the installation position when the electric device is turned from the horizontal state to the vertical state.

In one embodiment, the anti-detachment assembly comprises:
an auxiliary locking member configured to switch between an unlocking position for releasing the battery pack and a locking position for locking the battery pack; and
a retaining member configured to prevent the auxiliary locking member from displacing from the locking position to the unlocking position when the electric device is turned from the horizontal state to the vertical state.

In one embodiment, when the electric device is in the vertical state, the retaining member is coupled to the auxiliary locking member to prevent the auxiliary locking member from displacing from the locking position to the unlocking position; and
when the electric device is in the horizontal state, the retaining member is disengaged from the auxiliary locking member, and the auxiliary locking member is free to switch between the locking position and the unlocking position.

In one embodiment, when the electric device is in the vertical state, the retaining member is coupled to the auxiliary locking member by gravity, and when the electric device is in the horizontal state, the retaining member is disengaged from the auxiliary locking member by gravity.

In one embodiment, the anti-detachment assembly further comprises a second elastic member, the battery pack is provided with a notch, and the auxiliary locking member is configured to extend into the notch of the battery pack under elastic force of the second elastic member, and when the auxiliary locking member releases the battery pack, the battery pack can overcome the elastic force of the second elastic member during movement to disengage the auxiliary locking member from the notch.

In one embodiment, the anti-detachment assembly comprises:
an auxiliary locking member configured to switch between an unlocking position for releasing the battery pack and a locking position for locking the battery pack, wherein in the locking position, the auxiliary locking member locks the battery pack, and in the unlocking position, the auxiliary locking member releases the battery pack; and
a second detection assembly configured to detect whether the battery pack mounting structure is in the vertical state; and
a control member associated with the auxiliary locking member and the second detection assembly, wherein when the second detection assembly detects that the battery pack mounting structure is in the vertical state, the control member controls the auxiliary locking member to switch to the locking position.

In one embodiment, the battery pack mounting structure further comprises a compartment cover movably mounted on the mounting body and configured to cooperate with the mounting body to form an accommodation cavity for accommodating the battery pack, the compartment cover having a first position where the compartment cover cooperates with the mounting body to close the accommodation cavity, and a second position where the compartment cover is opened to allow access to the battery pack; and
wherein movement of the compartment cover from the first position to the second position is configured to trigger a position change of the locking mechanism to unlock the battery pack.

In one embodiment, the compartment cover is connected to the locking mechanism in a linkage manner, and when the compartment cover moves from the first position to the second position, the compartment cover drives the locking mechanism to change position to unlock the battery pack; and
the locking mechanism comprises: a main locking member and a linkage assembly;
the main locking member has a locking position for locking the battery pack in the accommodation cavity and an unlocking position for releasing the battery pack in the accommodation cavity; and
the linkage assembly is connected to the compartment cover and configured to act on the main locking member, wherein when the compartment cover moves from the first position to the second position, the linkage assembly drives the main locking member to move from the locking position to the unlocking position.

In one embodiment, when the locking mechanism unlocks the battery pack and the electric device is in the vertical state, the retaining member prevents the auxiliary locking member from displacing from the locking position of the auxiliary locking member to the unlocking position of the auxiliary locking member.

In one embodiment, the mounting body has an opening for accessing the battery pack by opening the compartment cover, and when the electric device is in the vertical state, the opening faces the ground.

The present disclosure also provides an electric device, the electric device comprises a battery pack mounting structure and a battery pack providing power, wherein when the electric device is placed horizontally on the ground, a center of gravity of the electric device has a ground clearance h1, and the battery pack mounting structure comprises:
a mounting body configured to support the battery pack; and
a locking mechanism configured to lock the battery pack to maintain the battery pack at an installation position or release the battery pack to allow the battery pack to detach from the installation position; and
an anti-detachment assembly, wherein when an electric tool rotates around a center of gravity of the electric tool at a certain angle, and causing a change in the ground clearance h1, the anti-detachment assembly is configured to prevent the battery pack from detaching from the installation position.

In one embodiment, the electric device is a push lawn mower, the push lawn mower comprises a main housing and a handle portion connected to the main housing, the battery pack mounting structure is connected to or integrally formed with the main housing; and
when the ground clearance h1 is raised by a preset distance in a direction perpendicular to the ground, the anti-detachment assembly is automatically triggered to prevent the battery pack from detaching from the installation position.

The present disclosure also provides an electric device, the electric device comprises a battery pack mounting structure and a battery pack providing power, the electric device has an opening for mounting the battery pack, the opening has an angle A with respect to a vertical direction, and the battery pack mounting structure comprises:
a mounting body configured to support the battery pack; and
a locking mechanism configured to lock the battery pack to maintain the battery pack at an installation position or release the battery pack to allow the battery pack to detach from the installation position; and
an anti-detachment assembly, when the angle A changes, the anti-detachment assembly is configured to prevent the battery pack from detaching from the installation position.

In one embodiment, the electric device is a push lawn mower, the push lawn mower comprises a mounting body and a handle portion connected to the mounting body, the battery pack mounting structure is connected to or integrally formed with the mounting body; and
when the angle A changes to less than or equal to 60 degrees, the anti-detachment assembly is automatically triggered to prevent the battery pack from detaching from the installation position.

According to another aspect of the present disclosure, a method for removing a battery pack based on the above battery pack mounting structure is also provided, the method for removing the battery pack comprises the following steps:
step S1: opening the compartment cover to move the compartment cover from the first position to the second position, the compartment cover drives the locking mechanism to unlock the battery pack in the accommodation cavity; and
step S2: removing the battery pack located in the accommodation cavity.

In one embodiment, before the step S1, the method further comprises:
step S0: unlocking the compartment cover of the battery pack to allow the compartment cover to separate from the mounting body.

In one embodiment, the compartment cover is magnetically attached to the mounting body, and the step S0 comprises: opening the compartment cover of the battery pack with a preset force to allow the compartment cover to separate from the mounting body.

In the technical solution provided by the present disclosure, when opening the compartment cover, the locking mechanism can be driven to unlock the battery pack simultaneously, without requiring additional actions to unlock the battery pack, making the operation simple, convenient and quick.

Other features and advantages of the present disclosure will be detailed in the following specific embodiments.

### BRIEF DESCRIPTION OF THE DRAWINGS

The accompanying drawings, which constitute a part of this application, are provided to facilitate further understanding of the present disclosure. The exemplary embodiments and descriptions of the exemplary embodiments are used to explain the present disclosure and do not constitute improper limitations of the present disclosure. In the drawings:

FIG. 1 is a structural diagram of a battery pack mounting structure according to one of embodiments of the present disclosure, wherein the compartment cover is in a first position;

FIG. 2 is a structural diagram of the battery pack mounting structure shown in FIG. 1 when the compartment cover is in a second position;

FIG. 3 is a structural diagram of the structure shown in FIG. 2 viewed from another angle;

FIG. 4 is an exploded view of the battery pack mounting structure shown in FIG. 1;

FIG. 5 is a structural diagram of the structure shown in FIG. 4 viewed from another angle;

FIG. 6 is a structural diagram showing a connection between the compartment cover and a locking mechanism according to one of embodiments of the present disclosure;

FIG. 7 is a partial structural diagram of FIG. 6;

FIG. 8 is a sectional view of FIG. 7;

FIG. 9 is a sectional view of the battery pack mounting structure according to one of embodiments of the present disclosure, the locking mechanism is in a locked state;

FIG. 10 is a partial structural diagram of FIG. 9;

FIG. 11 is a sectional view of the battery pack mounting structure according to one of embodiments of the present disclosure, wherein the locking mechanism is in an unlocked state;

FIG. 12 is a partial structural diagram of FIG. 11;

FIG. 13 is a structural diagram of a battery pack mounting structure according to one of embodiments of the present disclosure;

FIG. 14 is a structural diagram of the battery pack mounting structure of FIG. 13 with a battery pack removed;

FIG. 15 is an enlarged partial view of FIG. 14;

FIG. 16 is a structural diagram of a lawn mower according to one of embodiments of the present disclosure, the lawn mower is in a horizontal state;

FIG. 17 is a sectional view showing the battery pack mounting structure according to one of embodiments of the present disclosure installed in the lawn mower in the state shown in FIG. 16;

FIG. 18 is a partial enlarged view of FIG. 17;

FIG. 19 is a structural diagram of a lawn mower according to some embodiments of the present disclosure, wherein the lawn mower is in a vertical state;

FIG. 20 is a structural diagram of the lawn mower in FIG. 19 when the compartment cover is opened;

FIG. 21 is a sectional view showing the battery pack mounting structure according to one of embodiments of the present disclosure installed in the lawn mower in the state shown in FIG. 19;

FIG. 22 is a partial enlarged view of FIG. 21;

FIG. 23 is a structural diagram showing a change in height of a center of gravity G position of a push lawn mower according to one of embodiments of the present disclosure;

FIG. 24 is a structural diagram showing a change in orientation of an opening of a push lawn mower according to an embodiment of the present disclosure;

FIG. 25 is a structural diagram of a battery pack mounting structure according to one of embodiments of the present disclosure when the compartment cover is in the first position;

FIG. 26 is a structural diagram of the battery pack mounting structure shown in FIG. 25 when the compartment cover is in the second position.

### REFERENCE NUMERALS

1—mounting body; 11—base; 111—support wall; 12—protective shell; 13—bottom plate; 131—hole; 14—accommodation cavity; 15—opening; 2—compartment cover; 21—cover body; 22—rotating connection portion; 23—grip portion; 3—locking mechanism; 31—main locking member; 311—first guiding inclined surface; 312—through slot; 32—moving member; 321—second guiding inclined surface; 322—actuating slot; 33—base; 34—first elastic member; 35—actuating member; 4—pivot shaft; 5—anti—detachment assembly; 51—auxiliary locking member; 511—first inclined surface; 512—second inclined surface; 513—blocking portion; 52—second elastic member; 53—retaining member; 531—rotating shaft; 54—mounting seat; 9—battery pack.

### DETAILED DESCRIPTION

The following description will clearly and completely describe the technical solutions in the embodiments of the present disclosure with reference to the accompanying drawings. Obviously, the described embodiments are only a part of the embodiments of the present disclosure, not all of the embodiments of the present disclosure. All other embodiments obtained by those skilled in the art without creative work based on the embodiments of the present disclosure shall fall within the protection scope of the present disclosure. The embodiments and features in the embodiments of the present disclosure can be combined with each other when there is no conflict.

In the description of the present disclosure, it should be understood that terms such as “center”, “longitudinal”, “transverse”, “upper”, “lower”, “left”, “right”, “vertical”, “horizontal”, “top”, “bottom”, “axial”, “radial”, “circumferential” and the like indicating directional or positional relationships are based on the directional or positional relationships shown in the drawings, are merely for the convenience of describing the present disclosure and simplifying the description, and do not indicate or imply that a referred device or element must have a specific orientation, be constructed in a specific orientation and operate in a specific orientation, and therefore should not be construed as limitations of the present disclosure. In addition, “inner, outer” refers to the inner and outer relative to the outline of the components themselves.

Furthermore, the terms “first”, “second” are used only for descriptive purposes and cannot be understood as indicating or implying relative importance or implicitly indicating the number of technical features indicated. Thus, features limited by “first”, “second” may explicitly or implicitly include at least one such feature.

Electric devices typically use battery packs for power supply to facilitate use. To facilitate battery pack installation, electric devices are equipped with a battery pack mounting structure, the battery pack mounting structure includes a mounting body, a compartment cover, and a locking mechanism. The mounting body supports the battery pack, the compartment cover is movably mounted on the mounting body and cooperates with the mounting body to form an accommodation cavity for the battery pack. The compartment cover has a first position where the compartment cover cooperates with the mounting body to close the accommodation cavity, preventing grass clippings from entering, and a user unlocks the battery pack in the accommodation cavity by activating an unlock button in the locking mechanism.

Since a battery pack in an electric device is relatively heavy, an ejection structure in the accommodation cavity cannot eject the battery pack. In some embodiments, on the one hand, a user needs to continuously activate the unlock button with one hand while supporting the compartment cover with another hand. However, since the user cannot access the battery pack in the accommodation cavity, the user needs to free one hand to retrieve the battery pack from the accommodation cavity, making the operation extremely inconvenient. On the other hand, an operator needs an additional unlocking action to remove the battery pack from the accommodation cavity.

To solve these problems, the present disclosure provides a battery pack mounting structure comprising a mounting body, a compartment cover, and a locking mechanism. The mounting body supports a battery pack, the compartment cover is movably mounted on the mounting body and cooperates with the mounting body to form an accommodation cavity for the battery pack. The compartment cover has a first position where the compartment cover cooperates with the mounting body to close the accommodation cavity, and a second position where the compartment cover opens to allow access to the battery pack. The locking mechanism locks or unlocks the battery pack, and movement of the compartment cover from the first position to the second position can trigger a position change of the locking mechanism to unlock the battery pack. Compared to the existing technology where a user first opens a cover, then operates an unlock button to unlock a battery pack, and then retrieves the battery pack, the solution provided by this application makes battery pack retrieval simple, convenient and quick.

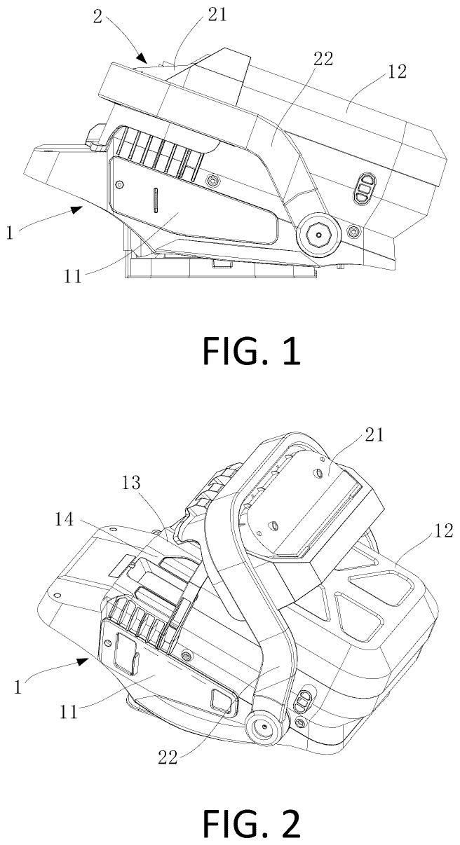

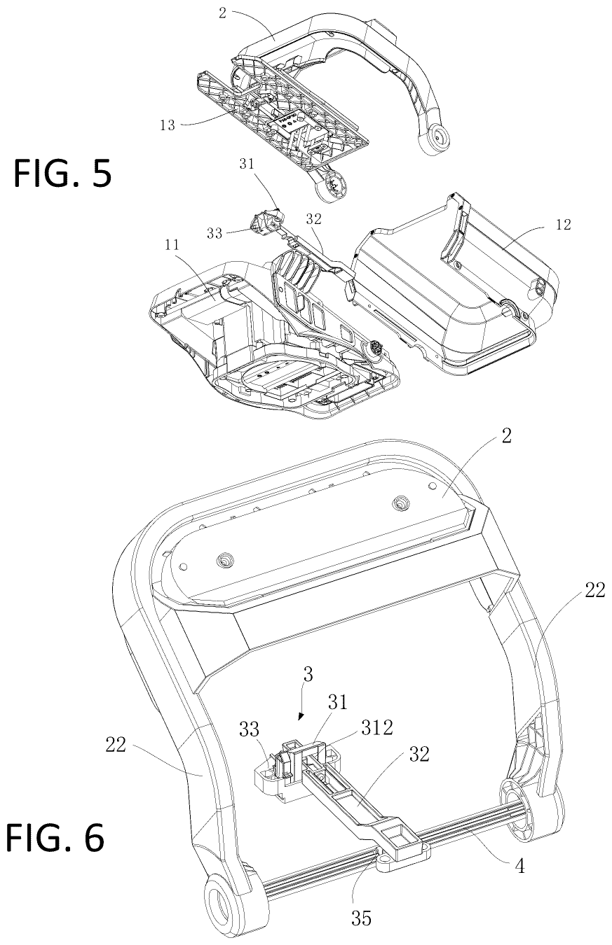

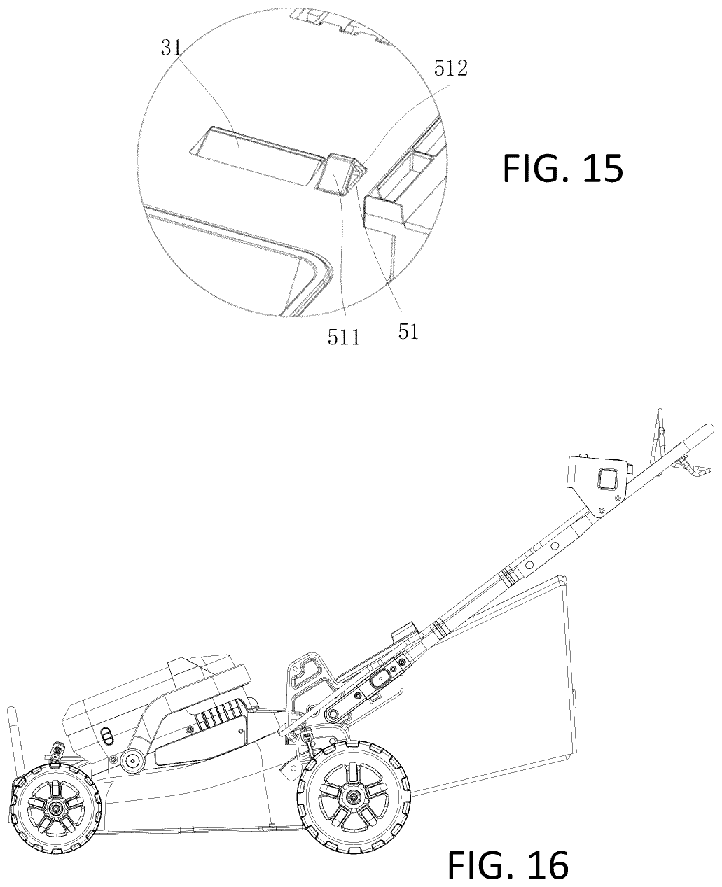

Specifically, in some embodiments, as shown in FIG. 1-15, a battery pack mounting structure includes:
a mounting body 1 configured to support a battery pack 9;
a compartment cover 2 movably mounted on the mounting body 1, and configured to cooperate with the mounting body 1 to form an accommodation cavity 14 for accommodating the battery pack 9, the compartment cover 2 having a first position where the compartment cover 2 cooperates with the mounting body 1 to close the accommodation cavity 14, and a second position where the compartment cover 2 opens the accommodation cavity 14 to allow access to the battery pack; and
a locking mechanism 3 configured to lock or unlock the battery pack 9, wherein the compartment cover 2 is connected to the locking mechanism 3 in a linkage manner, and during the process of the compartment cover 2 moving from the first position to the second position, the compartment cover 2 drives the locking mechanism 3 to change position to unlock the battery pack 9.

The battery pack mounting structure also has an opening 15 for accessing the battery pack 9 by opening the compartment cover 2, and the mounting body 1 is also provided with a slide rail for guiding the battery pack 9 to be inserted and locked in the accommodation cavity. In the technical solution provided by the present disclosure, during the process of opening the compartment cover 2, the compartment cover 2 can drive the locking mechanism 3 to unlock the battery pack 9, without requiring an additional action to unlock the battery pack 9. In other words, after opening the compartment cover 2, the battery pack 9 is unlocked and can be retrieved from the accommodation cavity 14, making the retrieval operation simple, convenient and quick, and eliminating the need for an additional unlocking member to drive the locking mechanism to unlock the battery pack 9.

In some embodiments, as shown in FIG. 1-8, when the compartment cover 2 is in the first position, the locking mechanism 3 locks the battery pack 9. The locking mechanism 3 is coupled with the compartment cover 2 through a mechanical connection, so that during the process of opening the compartment cover 2, the compartment cover 2 can drive the locking mechanism 3 to unlock the battery pack 9. The locking mechanism 3 comprises:
a main locking member 31 having a locking position for locking the battery pack 9 in the accommodation cavity 14 and an unlocking position for releasing the battery pack 9 in the accommodation cavity 14; and
a linkage assembly connected to the compartment cover 2 and configured to act on the main locking member 31, wherein when the compartment cover 2 moves from the first position to the second position, the linkage assembly drives the main locking member 31 to move from the locking position to the unlocking position.

In some embodiments, the battery pack mounting structure further comprises a reset assembly configured to move the main locking member 31 from the unlocking position to the locking position when the compartment cover 2 changes from the second position to the first position. That is, during the process of closing the opening of the accommodation cavity 14 by the compartment cover 2, the reset assembly drives the main locking member 31 to automatically lock the battery pack 9, without requiring an additional action to lock the battery pack 9, simply closing the compartment cover 2 is sufficient.

For example, the reset assembly comprises:
a base 33 disposed on the mounting body 1, with the main locking member 31 movably mounted in the base 33; and
a first elastic member 34 having one end pushing against the base 33 and another end pushing against the main locking member 31, wherein when the compartment cover 2 moves from the second position to the first position, the main locking member 31 moves from the unlocking position to the locking position under the action of the first elastic member 34.

Specifically, as shown in FIG. 8, a sliding groove can be provided on the base 33, with part of the main locking member 31 disposed in the sliding groove, allowing the main locking member 31 to move up and down along a direction defined by the sliding groove (a direction substantially perpendicular to a moving direction of a moving member 32). The first elastic member 34 can be a spiral spring, with spring seats provided on both the base 33 and the main locking member 31. One end of the spiral spring is installed on a spring seat of the base 33, and the other end is installed on a spring seat of the main locking member 31.

The base 33 can be formed separately and then mounted on the mounting body 1, or the base 33 can be directly formed on the mounting body 1.

In some embodiments, the compartment cover 2 is pivotally connected to the mounting body 1 and configured to rotate around an axis of a pivot shaft 4 to the first position and the second position respectively, and the linkage assembly comprises:
an actuating member 35 connected to the compartment cover 2 to rotate synchronously around the axis of the pivot shaft 4; and
a moving member 32 abutting against the actuating member 35 and configured to act on the main locking member 31, wherein when the compartment cover 2 rotates from the first position to the second position, the actuating member 35 pushes against the moving member 32, and the moving member 32 drives the main locking member 31 to move from the locking position to the unlocking position.

For example, the pivot shaft 4 is connected to the compartment cover 2 to rotate synchronously around an axis of the pivot shaft 4, and the actuating member 35 is disposed on the pivot shaft 4.

Specifically, as shown in the embodiment in FIG. 6, the compartment cover 2 includes a cover body 21 and rotating connection portions 22 on opposite sides of the cover body 21. The pivot shaft 4 is connected to the rotating connection portions 22 to rotate synchronously, for example, through a spline connection. During the process of the compartment cover 2 flipping from the first position to the second position relative to the mounting body 1 along with the pivot shaft 4, the pivot shaft 4 rotates with the actuating member 35, thereby the actuating member 35 drives the moving member 32 to move, and the moving member 32 drives the main locking member 31 to move from the locking position to the unlocking position.

In some embodiments, the linkage assembly is provided with a guiding portion, the main locking member 31 is connected to the moving member 32 through the guiding portion, the guiding portion is configured to guide the main locking member 31 to move along a preset path, and the locking position and the unlocking position are both located on the preset path.

The guiding portion comprises a first guiding inclined surface 311 and a second guiding inclined surface 321 abutting against each other, the first guiding inclined surface 311 is disposed on the main locking member 31, and the second guiding inclined surface 321 is disposed on the moving member 32. During the process of the compartment cover 2 changing from the first position to the second position, the actuating member 35 drives the moving member 32 to move, thereby the second guiding inclined surface 321 pushes the first guiding inclined surface 311 to move, causing the main locking member 31 to move from the locking position for locking the battery pack 9 to the unlocking position for unlocking the battery pack 9.

In some embodiments, the actuating member 35 is a pawl or a cam, and the moving member 32 is a push rod.

In other embodiments, the actuating member 35 can also be a gear, and the moving member 32 can be a rack. During the rotation of the pivot shaft 4 with the gear, the gear can drive the rack to move.

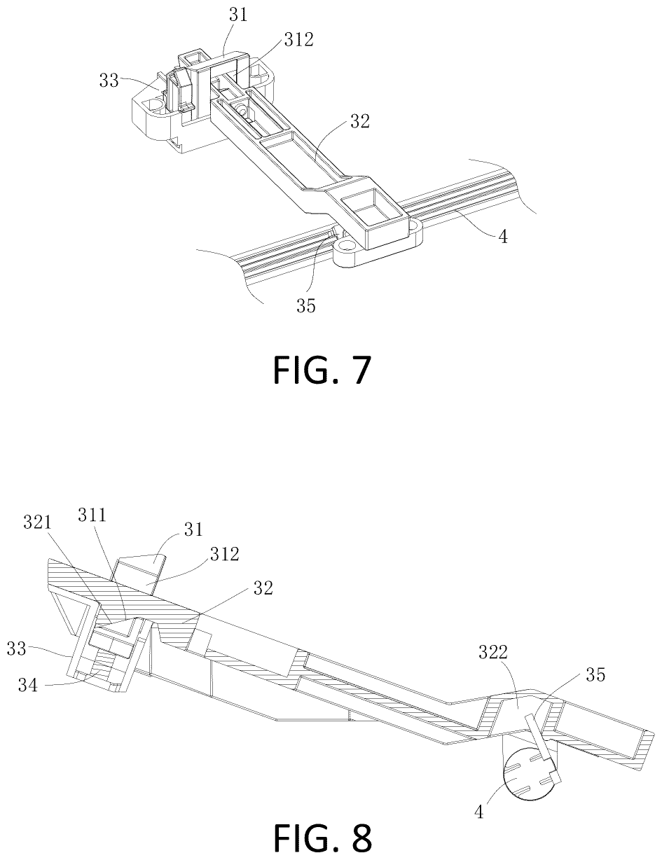

In the embodiment shown in FIGS. 7 and 8, the moving member 32 is a push rod, the actuating member 35 is a pawl, and an actuating slot 322 is provided on the moving member 32, with the actuating member 35 located in the actuating slot 322. When the pivot shaft 4 drives the actuating member 35 to rotate clockwise, the actuating member 35 can push against a side wall of the actuating slot 322, thereby moving the moving member 32.

Furthermore, a through slot 312 is provided on the main locking member 31, with one end of the moving member 32 extending through the through slot 312, so that the second guiding inclined surface 321 at a bottom of the moving member 32 fits against the first guiding inclined surface 311 on the main locking member 31 (as shown in FIG. 8). When the compartment cover 2 changes from the first position to the second position, the actuating member 35 drives the moving member 32 to move rightward (according to the orientation in FIG. 8), thereby the second guiding inclined surface 321 pushes the first guiding inclined surface 311 rightward. Since the main locking member 31 is constrained to move along a predetermined path, which in the embodiment shown in FIG. 8 is approximately perpendicular to the moving direction of the moving member 32, under the pushing force of the second guiding inclined surface 321, the main locking member 31 moves along the predetermined path to the unlocking position, that is the main locking member 31 retracts downward from a locking slot of the battery pack 9, unlocking the battery pack 9. At this time, the main locking member 31 compresses the first elastic member 34, and the first elastic member 34 is in a pre-loaded state. When the compartment cover 2 moves from the second position to the first position, the actuating member 35 releases the moving member 32, and the moving member 32 no longer applies pushing force to the first guiding inclined surface 311. The main locking member 31 moves to the locking position under the elastic force of the first elastic member 34, that is, extends upward into the locking slot of the battery pack 9 to lock the battery pack 9. Meanwhile, the movement of the main locking member 31 causes the first guiding inclined surface 311 to push the second guiding inclined surface 321, thereby resetting the moving member 32.

In some embodiments, as shown in FIG. 1-4, the mounting body 1 includes a base 11, a bottom plate 13, and a protective shell 12. An accommodation cavity 14 is formed between the protective shell 12 and the base 11, and the bottom plate 13 is installed on the base 11 within the accommodation cavity 14 to support a battery pack installed in the accommodation cavity 14.

The moving member 32 and the main locking member 31 are installed between the bottom plate 13 and the base 11. When the main locking member 31 moves from the unlocking position to the locking position, the main locking member 31 can extend upward through the bottom plate 13 to lock the battery pack. The bottom plate 13 is provided with a hole 131 for the main locking member 31 to extend through, and when the main locking member 31 moves from the locking position to the unlocking position, the main locking member 31 retracts downward through the bottom plate 13 to unlock the battery pack.

For example, the guiding structure are provided at a bottom of the bottom plate 13 to guide the movement of the moving member 32. This guiding structure can be guiding grooves, or guiding ribs that mate with sliding grooves on the moving member 32.

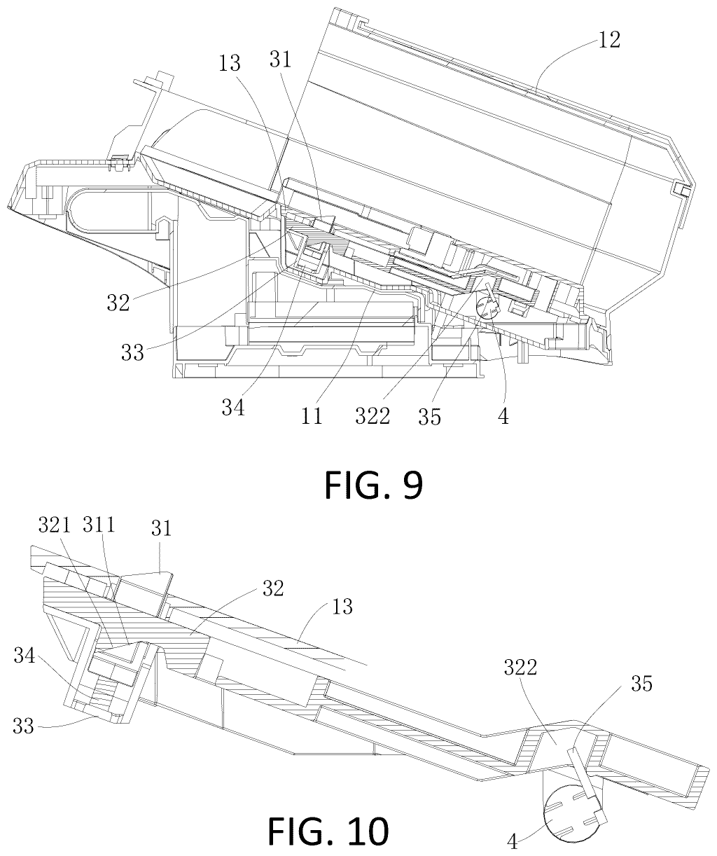

The following describes the specific process of removing and installing the battery pack according to the embodiment shown in FIG. 9-12.

FIGS. 9 and 10 show a state of the locking mechanism 3 when the compartment cover 2 is in the first position. At this time, the main locking member 31 of the locking mechanism 3 is in the locking position, that is, protruding upward through the bottom plate 13 to extend into a locking slot of the battery pack, thereby locking the battery pack in the accommodation cavity 14.

When rotating the compartment cover 2 from the first position to the second position, the actuating member 35 pushes the moving member 32 to move along with the rotation of the pivot shaft 4, thereby the second guiding inclined surface 321 of the moving member 32 pushes the first guiding inclined surface 311 of the main locking member 31, moving the main locking member 31 from the locking position to the unlocking position.

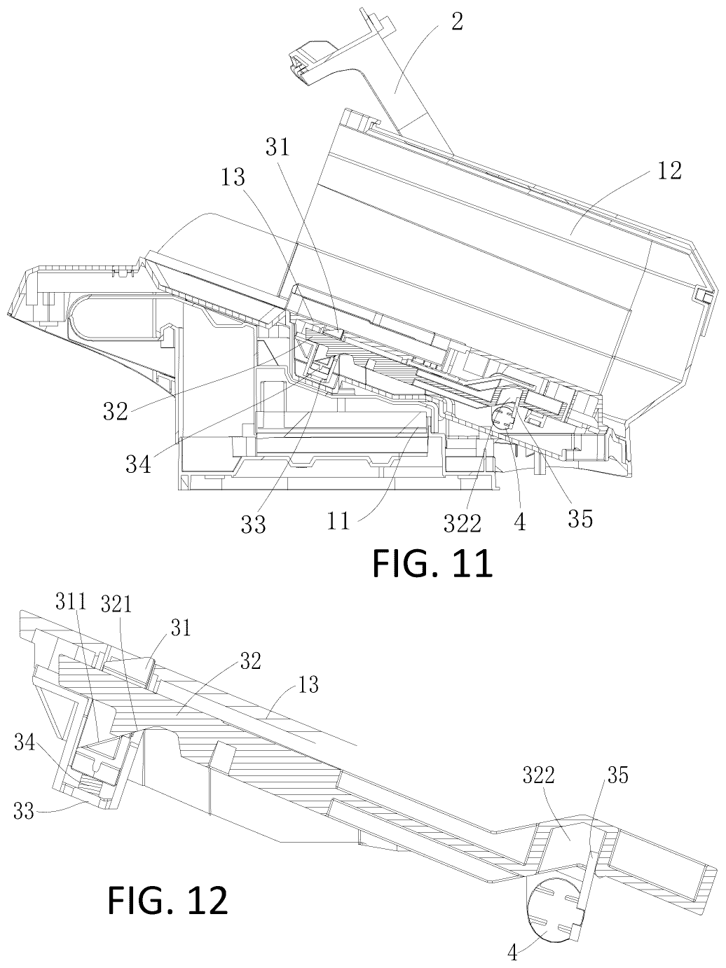

FIGS. 11 and 12 show the state of the locking mechanism 3 when the compartment cover 2 is in the second position. At this time, the main locking member 31 of the locking mechanism 3 retracts through the bottom plate 13 (in the unlocking position), the battery pack is unlocked, and can be removed through the opening of the accommodation cavity 14.

After charging and returning the battery pack to the accommodation cavity 14, when flipping the compartment cover 2 from the second position to the first position, the actuating member 35 rotates with the pivot shaft 4, releasing the moving member 32. At this time, the elastic force of the first elastic member 34 pushes the main locking member 31 upward, and the main locking member 31 moves to the locking position protruding through the bottom plate 13. Meanwhile, the first guiding inclined surface 311 of the main locking member 31 pushes the second guiding inclined surface 321 of the moving member 32, causing the moving member 32 to reset.

Those skilled in the art can understand that in the technical solution provided by the present disclosure, the locking mechanism is not limited to the structural form described in the above embodiments. In other embodiments, the locking mechanism can be coupled with the compartment cover 2 through electronic control, so that during the process of opening the compartment cover 2, the compartment cover 2 can drive the locking mechanism 3 to unlock the battery pack. The locking mechanism includes:
a main locking member having a locking position for locking a battery pack in the accommodation cavity 14 and an unlocking position for releasing the battery pack in the accommodation cavity 14; and
a first detection assembly connected to the mounting body 1 and configured to detect a position of the compartment cover 2; and
a first control portion associated with the main locking member and the first detection assembly, wherein when the first detection assembly detects that the compartment cover 2 moves from the first position to the second position, the first control portion controls the main locking member to move from the locking position to the unlocking position.

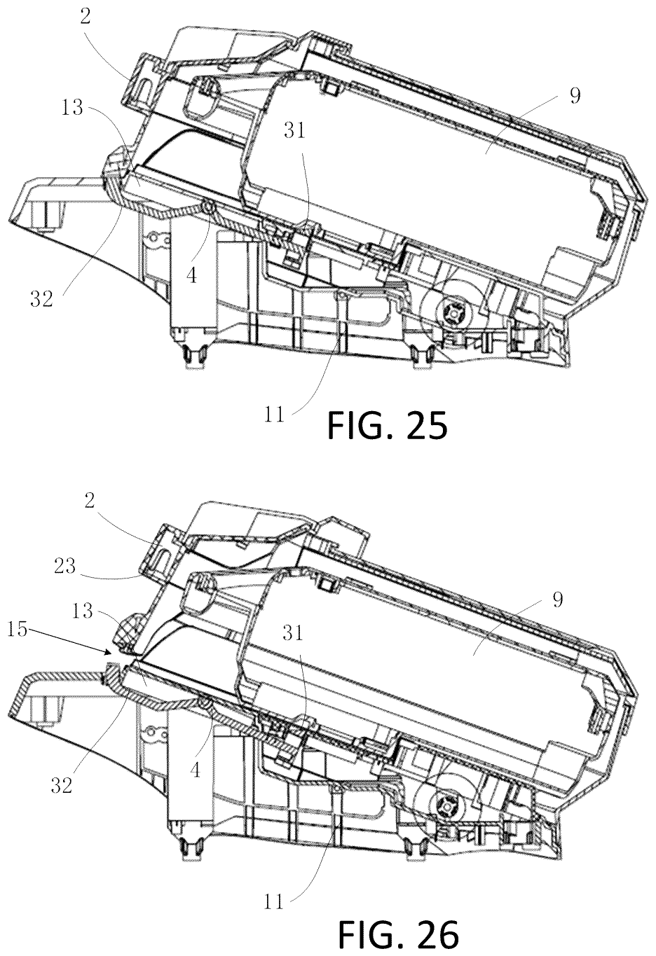

In other embodiments, instead of using an action of opening the compartment cover 2 to drive a linkage mechanism to unlock the locking mechanism 3, an action of unlocking the compartment cover 2 can be used to drive the linkage mechanism to unlock the locking mechanism 3. Specifically, as shown in FIG. 25-26, the moving member 32 of the linkage mechanism is pivotally connected to the bottom plate 13 through the pivot shaft 4, where the pivot shaft 4 is located in the middle section of the moving member 32. One end of the moving member 32 is configured to cooperate with the compartment cover 2 to keep the compartment cover 2 engaged with the bottom plate 13, and another end of the moving member 32 is configured to cooperate with the main locking member 31 of the locking mechanism 3 to lock or unlock the battery pack 9. The compartment cover 2 includes a grip portion 23 for an operator to grip and open the cover. A user can unlock the locking mechanism 3 by actuating the end of the moving member 32 that cooperates with the compartment cover 2, with a preset distance between the cooperating end and the grip portion 23. A separate unlocking mechanism can also be provided on the grip portion 23 of the compartment cover 2, so that when the operator lifts the compartment cover 2 with one hand, the operator can simultaneously touch the unlocking mechanism, which can actuate the moving member 32, thereby driving the locking mechanism 3 to unlock the battery pack 9. That is, opening the compartment cover and unlocking the battery pack 9 can be completed in one action. Of course, the locking mechanism 3 can also be set on the mounting body 1, and the preset distance between the locking mechanism 3 and the compartment cover 2 allows fingers or other parts of a same hand of the operator to touch the locking mechanism 3 when preparing to lift the compartment cover with one hand.

More specifically, the locking mechanism 3 can be an unlock button set on the grip portion 23 of the compartment cover. The unlock button can trigger other mechanical linkages or electronic linkage structures inside the compartment cover 2, which are not specifically restricted here.

It can also be understood that in the technical solution provided by the present disclosure, the compartment cover 2 is not limited to being mounted on the mounting body 1 through a flipping motion, the compartment cover 2 can also be installed to slide relative to the mounting body 1. For example, the compartment cover 2 can switch between the first position and the second position through a sliding motion via a linkage mechanism. When the compartment cover 2 moves from the first position to the second position relative to the mounting body 1, the compartment cover 2 can also drive a linkage component to act, thereby driving the main locking member 31 to move to the unlocking position, achieving battery pack unlocking. When the compartment cover 2 moves from the second position to the first position, a spring force can make the main locking member 31 move to the locking position, achieving battery pack locking.

Furthermore, the electric device has a horizontal state and a vertical state. When a user uses the device for work, transportation, or storage, the user switches the electric device between the horizontal state and the vertical state. The horizontal state can generally be understood as when the electric device can be directly started for work, and in this state, the electric device is often placed horizontally on the ground. The vertical state can generally be understood as when the compartment cover 2 is opened, the opening 15 of the electric device for accessing the battery pack faces downward. Here, “the opening 15 faces downward” should be understood as when the battery pack can easily detach from the opening 15, departing from a battery pack installation position. Therefore, “the opening 15 faces downward” includes both when the opening 15 faces the ground directly and when the opening 15 forms a certain angle with the ground, as long as this angle can cause the battery pack to detach from the installation position. Taking a push lawn mower as an example of an electric tool, the push lawn mower can switch from a horizontal state placed on flat ground to a vertical state where a handle portion is folded for storage; or the push lawn mower can switch from a horizontal state on flat ground to a state on a larger slope. As shown in FIG. 24, an electric device on the left is in a horizontal state, where an opening 15 of the electric device on the left forms an angle A1 with a direction of gravity. When A1 is greater than 90 degrees, it indicates that the opening 15 faces upward at this time; when A1 equals 90 degrees, the opening 15 is in a horizontal state. An electric device on the right is in a vertical state, where an opening 15 of the electric device on the right forms an angle A2 with the direction of gravity. When A2 is between 60-90 degrees, the opening 15 has a smaller downward inclination angle, when A2 is less than or equal to 60 degrees, the opening 15 has a larger downward inclination angle, making it easier for a battery pack 9 to detach from the installation position through the opening 15.

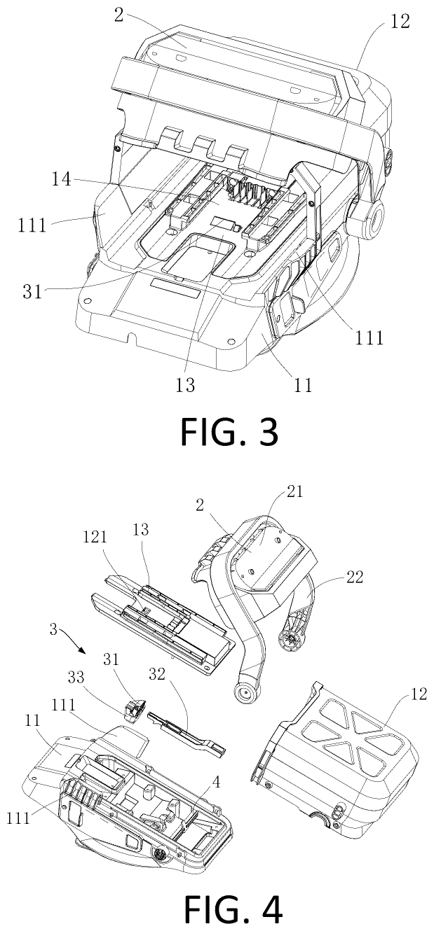

On one hand, to prevent the battery pack from easily falling along a slide rail under gravity if a user accidentally unlocks a locking mechanism during use, transportation, or storage of the electric device, this embodiment provides an electric device comprising a mounting body, a locking mechanism, and an anti-detachment assembly. The mounting body supports the battery pack, the locking mechanism locks the battery pack in the installation position or releases the battery pack to allow detachment, and the anti-detachment assembly is configured to prevent the battery pack from detaching from the mounting body when the electric device is turned from the horizontal state to the vertical state. Furthermore, referring to FIG. 3, in this embodiment, the locking mechanism and the anti-detachment assembly are arranged side by side on a mounting surface of the mounting body in a direction perpendicular to battery pack insertion.

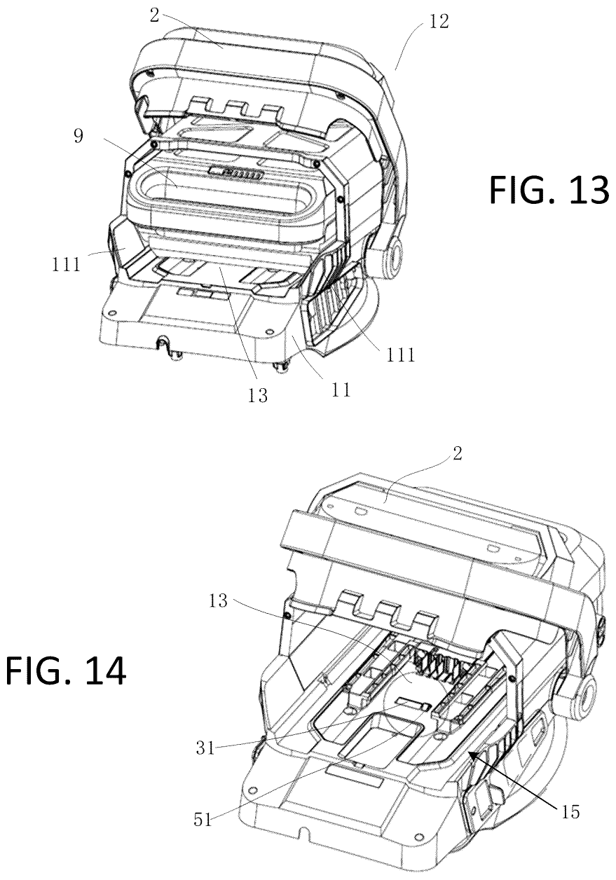

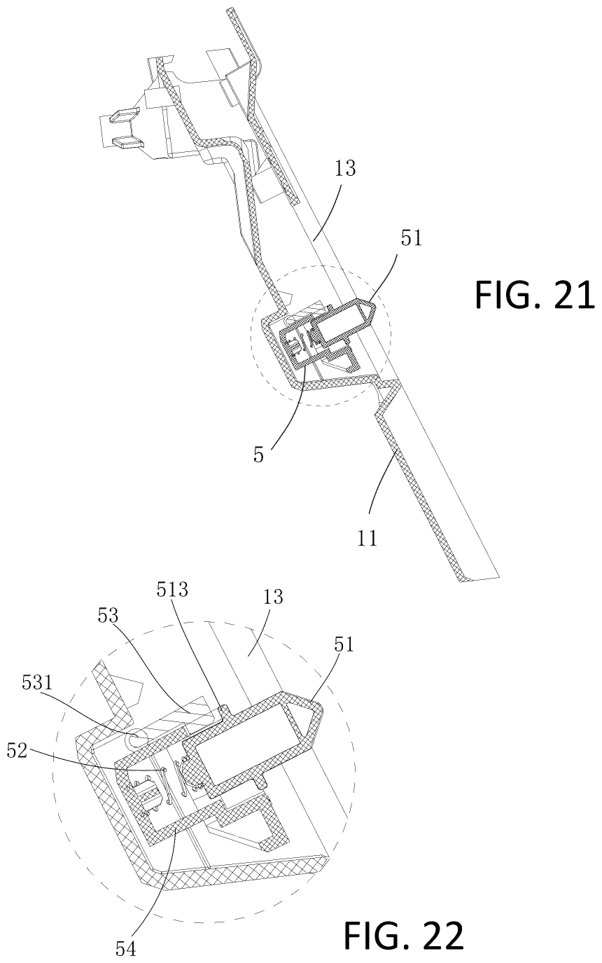

To prevent the battery pack from falling out during state switching of the electric device, this embodiment also provides an electric device. Referring to FIGS. 13 to 18 and FIG. 24, this electric device includes a battery pack mounting structure and a battery pack 9 providing power. The electric device has an opening 15 for mounting the battery pack 9, and an orientation of the opening 15 forms an angle A with a plane containing a gravity direction. The battery pack mounting structure includes a mounting body 1, a locking mechanism 3, and an anti-detachment assembly 5. The mounting body 1 supports the battery pack 9, the locking mechanism 3 locks the battery pack 9 to maintain the battery pack 9 in an installation position or releases the battery pack 9 to allow detachment, and when the angle A is less than or equal to 60 degrees, the anti-detachment assembly 5 is configured to prevent the battery pack 9 from detaching from the installation position. Specifically, taking a push lawn mower as an example, as shown in FIGS. 13 to 22 and FIG. 24, the push lawn mower has a first posture for vertical storage placement and a second posture for horizontal placement on the ground. In the second posture, a direction of the opening 15 forms an angle A1 with the plane containing the gravity direction, where the angle A1 ranges from 60-120 degrees. In the first posture, the direction of the opening 15 forms an angle A2 with the plane containing the gravity direction, where the angle A2 ranges from 0-60 degrees.

Furthermore, it can be understood that when the battery pack 9 is in the installation position, the battery pack 9 may slightly wobble in the installation position, as long as the battery pack 9 maintains electrical connection with an electrical connector on the electric device. When the battery pack 9 detaches from the installation position, the battery pack 9 disconnects electrically from the electric device.

According to another aspect of the present disclosure, an electric device is provided. This electric device includes a battery pack mounting structure and a power-providing battery pack. When the electric device is placed horizontally on the ground, a center of gravity of the electric device has a ground clearance H. During the process of lifting or rotating the electric device to change posture, a large-capacity battery pack is usually heavy, increasing a risk of the battery pack slipping. To solve this problem, the battery pack mounting structure includes a mounting body, a locking mechanism, and an anti-detachment assembly. The mounting body supports the battery pack, the locking mechanism locks the battery pack to maintain the battery pack in an installation position or releases the battery pack to allow detachment, and when an electric tool rotates around a center of gravity of the electric tool at a certain angle, causing a change in the ground clearance H, the anti-detachment assembly is configured to prevent the battery pack from detaching from the installation position.

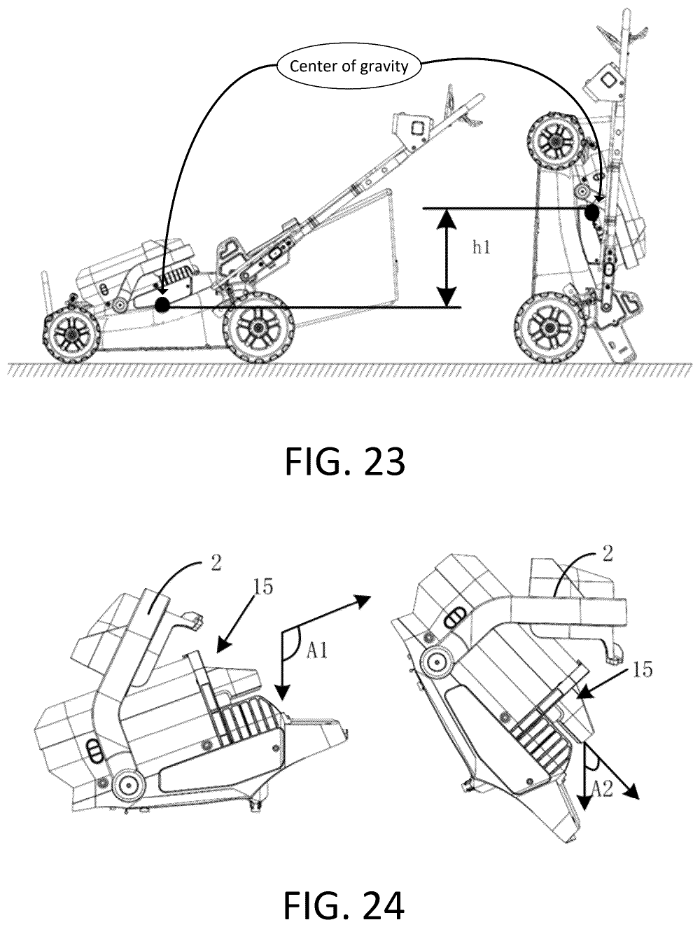

Specifically, the electric device is a push lawn mower. Referring to FIGS. 13 to 23, when the push lawn mower is in a horizontal state, a center of gravity G of the push lawn mower is basically located below a battery pack 9. When the push lawn mower is in a vertical state, a position of the center of gravity G changes, with the center of gravity in the vertical state raised by a distance h1 compared to the horizontal state. At this time, the push lawn mower is in a transport state. To make it more difficult for an operator to easily unlock the battery pack 9, maintain more stable machine operation, and ensure operator safety, the push lawn mower includes a device body and a handle portion connected to the device body. The battery pack mounting structure is connected to or integrally formed with the device body. When the ground clearance H is raised by a preset distance h1 in a direction perpendicular to the ground, an anti-detachment assembly 5 is automatically triggered to prevent the battery pack 9 from detaching from an installation position, keeping the battery pack 9 more securely in the installation position, thus making the push lawn mower safer during transport or rotation. The center of gravity G here is the center of gravity with the battery pack 9 installed.

In the above embodiments, on the one hand, both a locking mechanism 3 and an anti-detachment assembly 5 can lock a battery pack 9. on the one hand, when an electric device is in a vertical state or during shaking, a large-capacity battery pack 9 is usually heavy, increasing a risk of the battery pack 9 slipping. Even if an operator has not triggered the locking mechanism 3 to be in an unlocked state, a dual independent locking through the locking mechanism 3 and the anti-detachment assembly 5 can make the locking of a battery pack mounting structure more reliable and safer to use. On the other hand, in this embodiment, opening the compartment cover 2 can unlock the locking mechanism 3. If at this time the opening 15 for removal and installation of the battery pack 9 is facing downward, that is, when an insertion direction of the battery pack 9 is tilted downward, the battery pack 9 would detach from an installation position under gravity and might injure a user's feet or damage the battery pack through impact. However, the anti-detachment assembly 5 can keep the battery pack 9 in the installation position even when the locking mechanism 3 is unlocked, preventing the battery pack 9 from detaching from the installation position, making the locking of the battery pack mounting structure more reliable and safer to use.

As a specific implementation, taking a push lawn mower as an example of an electric tool, the push lawn mower includes a device body, a handle portion connected to the device body, and a wheel assembly driving the device body forward. A battery pack mounting structure is connected to or integrally formed with the device body. When transporting or storing the lawn mower, or when the lawn mower is moving uphill, an inclination angle of the lawn mower is relatively large. At this time, an opening for a user to remove and install a battery pack 9 faces downward. Since the battery pack 9 of the lawn mower is relatively heavy, usually weighing 5 Kg-10 Kg, if the user accidentally or unintentionally opens a compartment cover 2, the battery pack 9 would detach from an opening 15 of an accommodation cavity 14 under gravity, potentially injuring the user's feet or damaging the battery pack 9 through impact. This problem also occurs in other battery pack mounting structures, for example, when a user can unlock a main locking member 31 while unlocking the compartment cover 2, or when the main locking member 31 has been unlocked before the compartment cover 2 opens the accommodation cavity 14 for the user to remove the battery pack 9. To prevent the battery pack 9 from detaching through the opening 15 when the opening 15 of the accommodation cavity 14 faces downward, in some embodiments, the battery pack mounting structure can include an anti-detachment assembly 5, which is configured to prevent the battery pack 9 from detaching through the opening 15 when the battery pack mounting structure is in a vertical posture where the opening 15 of the accommodation cavity 14 faces downward. It can be understood that the electric device can also be other garden power tools, such as chain saws, grass trimmers, hedge trimmers, blowers, etc.

Specifically, an anti-detachment assembly includes an auxiliary locking member and a retaining member. The auxiliary locking member is configured to switch between an unlocking position for releasing a battery pack and a locking position for locking the battery pack. The retaining member is configured to keep the auxiliary locking member always in the locking position when an electric device is turned from a horizontal state to a vertical state, thereby enabling control of the auxiliary locking member to lock or unlock the battery pack simply by controlling the retaining member, making the structure simple and reliable.

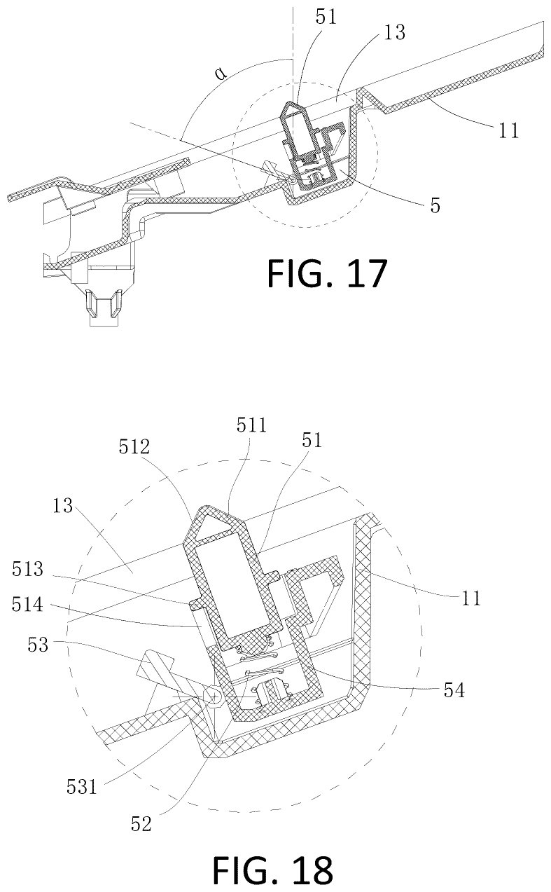

In some embodiments, when an electric device is in a vertical state, a retaining member is coupled to an auxiliary locking member and prevents the auxiliary locking member from displacing from a locking position to an unlocking position; when the electric device is in a horizontal state, the retaining member is disengaged from the auxiliary locking member, allowing the auxiliary locking member to freely switch between the locking position and the unlocking position. As shown in FIGS. 17 and 22, an anti-detachment assembly 5 includes an auxiliary locking member 51 and a retaining member 53; wherein the auxiliary locking member 51 is configured to switch between a third position and a fourth position. The third position is the locking position, where the auxiliary locking member 51 extends into a notch of a battery pack 9 in an accommodation cavity 14 to lock the battery pack, and the fourth position is the unlocking position, where the auxiliary locking member 51 releases the battery pack 9.

The retaining member 53 is configured to switch between a fifth position and a sixth position. When the retaining member 53 is in the fifth position, the retaining member 53 can keep the auxiliary locking member 51 in the third position, and when in the sixth position, the retaining member 53 releases the auxiliary locking member 51.

When a battery pack mounting structure is in the vertical state, the retaining member 53 switches to the fifth position, and when the battery pack mounting structure changes to the horizontal state where an opening 15 of the accommodation cavity 14 faces upward, the retaining member 53 switches to the sixth position.

Furthermore, the anti-detachment assembly 5 also includes a second elastic member 52. The auxiliary locking member 51 is configured to extend into the notch of the battery pack 9 under an elastic force of the second elastic member 52, and when the auxiliary locking member 51 releases the battery pack 9, the battery pack 9 can overcome the elastic force of the second elastic member 52 during movement and push the auxiliary locking member 51 to the fourth position.

For example, when an electric device is in a vertical state and a horizontal state respectively, a retaining member couples with and disengages from an auxiliary locking member by gravity. Specifically, the retaining member 53 is set to be rotatable; when a battery pack mounting structure is in a first posture, that is the vertical state, the retaining member 53 automatically rotates under gravity to rest on the auxiliary locking member 51 in a fifth position, thereby keeping the auxiliary locking member 51 in a third position, allowing the auxiliary locking member 51 to lock a battery pack 9 in an accommodation cavity 14. When the battery pack mounting structure changes to a second posture, that is the horizontal state, the retaining member 53 automatically rotates to a sixth position under gravity, releasing the auxiliary locking member 51, allowing the auxiliary locking member 51 to be compressed back to a fourth position by the battery pack 9 moving outward, thus releasing the battery pack 9.

Specifically, as shown in FIGS. 13 to 15, when an auxiliary locking member 51 is in a third position, the auxiliary locking member 51 protrudes upward through a bottom plate 13, enabling the auxiliary locking member 51 to extend into a notch of a battery pack 9 in an accommodation cavity 14. When removing the battery pack 9, an outward movement of the battery pack 9 can compress the auxiliary locking member 51, causing the auxiliary locking member 51 to retract downward to a fourth position.

A specific installation of an anti-detachment assembly 5 can be referenced in FIG. 17-18 and FIG. 21-22.

An auxiliary locking member 51 is movably mounted on a mounting seat 54 below a bottom plate 13, with a second elastic member 52 set between the mounting seat 54 and the auxiliary locking member 51. Under an elastic force of the second elastic member 52, the auxiliary locking member 51 protrudes upward through the bottom plate 13, thus being in a third position.

Among them, an end of the auxiliary locking member 51 that protrudes upward through the bottom plate 13 has a first inclined surface 511 and a second inclined surface 512. The first inclined surface 511 is on a side of the auxiliary locking member 51 facing an opening 15 of an accommodation cavity 14, and the second inclined surface 512 is on a side of the auxiliary locking member 51 away from the opening 15 of the accommodation cavity 14. This way, when removing a battery pack 9 from the accommodation cavity 14, the battery pack 9 compresses the auxiliary locking member 51 along the second inclined surface 512, causing the auxiliary locking member 51 to retract downward to a fourth position. When returning the battery pack 9 to the accommodation cavity 14, the battery pack 9 compresses the auxiliary locking member 51 along the first inclined surface 511, causing the auxiliary locking member 51 to retract downward to the fourth position. When the battery pack 9 moves to where the auxiliary locking member 51 aligns with a notch of the battery pack 9, the auxiliary locking member 51 springs out and enters the notch of the battery pack 9, at which point the auxiliary locking member 51 is in the third position.

A retaining member 53 is rotatably mounted on a base 11 or a mounting seat 54 through a rotating shaft 531, with a center of gravity of the retaining member 53 set away from the rotating shaft 531, allowing the retaining member 53 to automatically rotate between a fifth position and a sixth position under gravity according to a posture of a mounting structure of an accommodation cavity 14.

When a battery pack mounting structure is in a horizontal state with an opening 15 of an accommodation cavity 14 facing upward, for example, when a lawn mower with the battery pack mounting structure is in the horizontal state (as shown in FIG. 16), a retaining member 53 rotates to and remains in a sixth position under gravity, as shown in FIGS. 17 and 18, at this time, the retaining member 53 does not affect a movement of an auxiliary locking member 51.

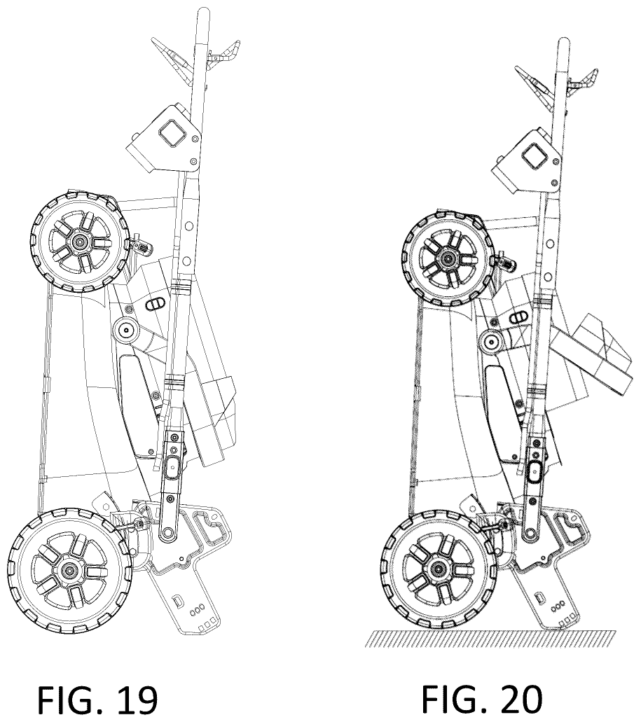

When a battery pack mounting structure is in a vertical state with an opening 15 of an accommodation cavity 14 facing downward, for example, when a lawn mower with the battery pack mounting structure is in the vertical state (as shown in FIG. 19), a retaining member 53 rotates under gravity to a sixth position, at this time, the retaining member 53 rotates under gravity to rest on an auxiliary locking member 51 and is in a fifth position.

Among them, the auxiliary locking member 51 is provided with a blocking portion 513, referring to FIGS. 18 and 22, when the retaining member 53 rests on the auxiliary locking member 51, the retaining member 53 cooperates with the blocking portion 513 to prevent the auxiliary locking member 51 from moving from a third position to a fourth position, thereby keeping the auxiliary locking member 51 locking a battery pack. In other words, when the battery pack mounting structure is in a state where the opening 15 of the accommodation cavity 14 faces downward and a compartment cover 2 is opened, as shown in FIGS. 20 to 22, the auxiliary locking member 51 is in the third position locking a battery pack 9, preventing the battery pack 9 from detaching downward from the accommodation cavity 14.

It can be understood that an anti-detachment assembly 5 is not limited to the structural form described above. In other embodiments, the anti-detachment assembly 5 can also be in an electronic control form.

Specifically, in some embodiments, an anti-detachment assembly can include:
an auxiliary locking member configured to move between a third position and a fourth position, where in the third position, the auxiliary locking member extends into a notch of a battery pack in an accommodation cavity to lock the battery pack, and in the fourth position, the auxiliary locking member releases the battery pack; and
a first detection assembly configured to detect whether a battery pack mounting structure is in a first posture; and
a second control portion associated with the auxiliary locking member and the first detection assembly, wherein when the first detection assembly detects that the battery pack mounting structure is in the first posture, the second control portion controls the auxiliary locking member to move to the third position.

To prevent a battery pack 9 from detaching through an opening 15 when the opening 15 of an accommodation cavity 14 faces downward, other methods can also be used.

For example, in some embodiments, a battery pack mounting structure also includes: a retaining member configured to move between a seventh position and an eighth position; and
in the seventh position, the retaining member can keep a main locking member 31 in a locking position, and in the eighth position, the retaining member releases the main locking member 31.

After the main locking member 31 is released by the retaining member, the main locking member 31 can move to an unlocking position when a compartment cover 2 opens to a second position as described above, and move to the locking position when the compartment cover 2 moves to a first position.

When a battery pack mounting structure is in a vertical state with an opening 15 of an accommodation cavity 14 facing downward, the retaining member switches to the seventh position, and when the battery pack mounting structure changes to a horizontal state with an opening of the accommodation cavity facing upward, the retaining member switches to the eighth position.

A configuration of the retaining member in this embodiment can be the same as that of a retaining member 53 used for retaining an auxiliary locking member 51 described above. When a battery pack mounting structure is in a vertical state, the retaining member can be configured to rotate to rest against a main locking member 31, keeping the main locking member 31 in a locking position, thereby maintaining a battery pack in a locked state and preventing a compartment cover 2 from opening in the vertical state.

Additionally, in some embodiments, a battery pack mounting structure can also include a spring member, which can be configured similarly to an auxiliary locking member 51 described above, configured to protrude upward through a bottom plate 13 under an elastic force of an elastic member to engage with a battery pack 9, and retracting downward when pushed by the battery pack 9. Thus, when a battery pack 9 is inserted into an accommodation cavity 14, the battery pack 9 pushes down the spring member, which retracts downward. As the battery pack 9 continues moving into the accommodation cavity 14, when the spring member aligns with a notch of the battery pack 9, the spring member springs out under the action of the elastic member, producing a “click” sound that can be used to detect whether the battery pack 9 is properly installed.

It can be understood that in embodiments with an auxiliary locking member 51 described above, installing a battery pack 9 into an accommodation cavity 14 will also produce a “click” sound from the auxiliary locking member 51, in which case a spring member may not be necessary.

Furthermore, in the embodiments provided by this application, when a compartment cover 2 closes an accommodation cavity 14, the compartment cover 2 needs to connect with a mounting body 1, and there can be multiple ways for the compartment cover 2 to connect with the mounting body 1.

In some embodiments, as shown in FIGS. 3 and 4, a base 11 has support walls 111 on opposite sides of an opening 15 of an accommodation cavity 14, and a compartment cover 2 is configured to engage with the support walls 111; and
wherein an upper portion of the support walls 111 forms a guiding portion for guiding an engagement of the compartment cover 2, which can engage with the support walls 111 when pressed. Specifically, the guiding portion at the upper part of the support walls 111 gradually slopes outward from top to bottom, so when the compartment cover 2 first contacts the guiding portion, there is a larger gap between the compartment cover 2 and the guiding portion. As the compartment cover 2 flips downward, the gap gradually decreases and forms an interference fit with the compartment cover 2. When pressing the compartment cover 2, the compartment cover 2 pressures the support walls causing slight deformation, the compartment cover 2 is stretched, and with continued pressing, the compartment cover 2 clicks into engagement with the support walls 111.

In some embodiments, a magnetic attachment component can also be provided between a compartment cover 2 and a mounting body 1. When the compartment cover 2 is in a position closing an accommodation cavity 14, the compartment cover 2 is fixed to the mounting body 1 through the magnetic attachment component.

When opening a compartment cover 2, an operator can manually push the compartment cover 2 to flip or slide the compartment cover 2 to open an accommodation cavity 14. In other embodiments, a driving mechanism can be provided between the compartment cover 2 and a mounting body 1, with control components set on an electric device equipped with this battery pack mounting structure. For example, control components (such as operation buttons) can be set at convenient locations like a handle or other positions of the electric device. When wanting to open the compartment cover 2, the driving mechanism can be controlled through the control components to open the compartment cover 2.

Additionally, a locking mechanism can be provided between a compartment cover 2 and a mounting body 1. When the compartment cover 2 closes an accommodation cavity, the compartment cover 2 can be locked to the mounting body 1 through the locking mechanism.

In the solution provided by this application, to facilitate battery retrieval, a retention mechanism can also be provided between a compartment cover 2 and a mounting body 1. When the compartment cover 2 is in a second position, the retention mechanism keeps the compartment cover 2 in the second position, eliminating the need to hold the compartment cover 2 manually, and making battery pack retrieval more convenient. For example, the retention mechanism can be a cylinder that extends when the compartment cover 2 flips open, supporting and maintaining the compartment cover 2 in an open position, and retracts when the compartment cover 2 flips closed.

According to another aspect of this application, a battery pack mounting structure is also provided, comprising:
a mounting body 1 forming an accommodation cavity 14 with an opening 15, the accommodation cavity 14 being configured to accommodate a battery pack 9; and
a compartment cover 2 movably mounted on the mounting body 1, having a first position where the compartment cover 2 cooperates with the mounting body 1 to close the accommodation cavity 14, and a second position where the compartment cover 2 opens the accommodation cavity 14 to allow access to the battery pack 9; and
a locking mechanism 3 configured to lock or release the battery pack 9; and
an anti-detachment assembly 5, when the locking mechanism releases the battery pack 9, and the battery pack mounting structure is in a vertical state with the opening 15 of the accommodation cavity 14 facing downward, the anti-detachment assembly 5 can prevent the battery pack 9 from detaching through the opening 15.

In some embodiments, an anti-detachment assembly 5 includes an auxiliary locking member 51 and a retaining member 53; wherein
the auxiliary locking member 51 is configured to switch between a third position and a fourth position. In the third position, the auxiliary locking member 51 extends into a notch of a battery pack 9 in an accommodation cavity 14 to lock the battery pack 9, and in the fourth position, the auxiliary locking member 51 releases the battery pack 9.

A retaining member 53 is configured to switch between a fifth position and a sixth position. When the retaining member 53 is in the fifth position, the retaining member 53 can keep the auxiliary locking member 51 in the third position, and when in the sixth position, the retaining member 53 releases the auxiliary locking member 51.

When a battery pack mounting structure is in a vertical state, the retaining member 53 switches to the fifth position, and when the battery pack mounting structure changes to a horizontal state with an opening 15 of an accommodation cavity 14 facing upward, the retaining member 53 switches to the sixth position.

Furthermore, the anti-detachment assembly 5 also includes a second elastic member 52. The auxiliary locking member 51 is configured to extend into a notch of a battery pack 9 under an elastic force of the second elastic member 52, and when the auxiliary locking member 51 releases the battery pack 9, the battery pack 9 can overcome the elastic force of the second elastic member 52 during movement and push the auxiliary locking member 51 to a fourth position.

In some embodiments, a retaining member 53 is configured to be rotatable; when a battery pack mounting structure is in a vertical state, the retaining member 53 automatically rotates under gravity to rest on an auxiliary locking member 51 in a fifth position, thereby keeping the auxiliary locking member 51 in a third position, allowing the auxiliary locking member 51 to lock a battery pack 9 in an accommodation cavity. When the battery pack mounting structure changes to a horizontal state, the retaining member 53 automatically rotates to a sixth position under gravity, releasing the auxiliary locking member 51, allowing the auxiliary locking member 51 to be compressed back to the fourth position by an outward movement of the battery pack 9, thus releasing the battery pack 9.

In another embodiment, an anti-detachment assembly 5 can also be in an electronic control form. Specifically, the anti-detachment assembly 5 can include:
an auxiliary locking member configured to move between a third position and a fourth position, where in the third position, the auxiliary locking member extends into a notch of a battery pack in an accommodation cavity to lock the battery pack, and in the fourth position, the auxiliary locking member releases the battery pack; and
a first detection assembly configured to detect whether a battery pack mounting structure is in a first posture; and
a second control portion associated with the auxiliary locking member and the first detection assembly, wherein when the first detection assembly detects that the battery pack mounting structure is in the first posture, the second control portion controls the auxiliary locking member to move to the third position.

To prevent a battery pack 9 from detaching through an opening 15 when the opening 15 of an accommodation cavity 14 faces downward, other methods can also be used.

For example, in some embodiments, a locking mechanism 3 includes: a main locking member 31 and a linkage assembly; and
the main locking member 31 has a locking position for locking a battery pack 9 in an accommodation cavity 14 and an unlocking position for releasing the battery pack 9 in the accommodation cavity 14; the linkage assembly is connected to a compartment cover 2 and can act on the main locking member 31, when the compartment cover 2 moves from a first position to a second position, the linkage assembly drives the main locking member 31 from the locking position to the unlocking position; and
an anti-detachment assembly 5 includes: a retaining member configured to move between a seventh position and an eighth position; in the seventh position, the retaining member can keep the main locking member 31 in the locking position to prevent the battery pack 9 from detaching through an opening 15, and in the eighth position, the retaining member releases the main locking member 31; wherein when a battery pack mounting structure is in a vertical state with the opening 15 of the accommodation cavity 14 facing downward, the retaining member switches to the seventh position, and when the battery pack mounting structure changes to a horizontal state with the opening 15 facing upward, the retaining member switches to the eighth position.

Based on the electric device provided by this application, the application also provides a method for removing a battery pack based on the above battery pack mounting structure, comprising:
step S1: opening a compartment cover, moving the compartment cover from a first position to a second position, whereby the compartment cover triggers a locking mechanism to unlock a battery pack in an accommodation cavity; and
step S2: removing the battery pack from the accommodation cavity.

Using this method, when a user unlocks a battery, the user can drive the locking mechanism to unlock the battery pack simply by opening the compartment cover, without needing to manually trigger an unlock button of the battery pack, making the operation simple and convenient, and improving usability.

Since most compartment covers have a locking structure, before a user employs this battery pack removal method, the method includes step S0, which is to unlock a compartment cover of a battery pack, allowing the compartment cover to separate from a mounting body.

Furthermore, to reduce an unlocking action required by a user to unlock a battery pack compartment cover, while still keeping the compartment cover locked to a mounting body, the compartment cover can be engaged with the mounting body using a preset force. This way, the user can open the battery pack compartment cover with a preset force, which not only serves to lock the compartment cover and the mounting body together but also makes it convenient for the user to open the battery pack compartment cover. In some embodiments provided by this application, the compartment cover is magnetically attached to the mounting body, and correspondingly, step S0 is: opening the battery pack compartment cover with a preset force to allow the compartment cover to separate from the mounting body. It can be understood that in other embodiments, an attachment force between the compartment cover and the mounting body can also be provided through an elastic deformation of the compartment cover or the mounting body, utilizing an elastic force generated by the deformation, which is not specifically restricted here.

The above description only represents the example embodiments of this application and is not intended to limit the application. Any modifications, equivalent replacements, etc., made within the spirit and principles of this application should be included within the protection scope of this application.

What is claimed is:

1. A battery pack mounting structure comprising:
a mounting body configured to support a battery pack;
a compartment cover movably mounted at the mounting body and configured to cooperate with the mounting body to form an accommodation cavity for accommodating the battery pack, the compartment cover including a first position where the compartment cover cooperates with the mounting body to close the accommodation cavity and a second position where the compartment cover is opened to allow access to the battery pack; and
a locking mechanism configured to lock or unlock the battery pack,
wherein movement of the compartment cover from the first position to the second position is configured to trigger a position change of the locking mechanism to unlock the battery pack.

2. The battery pack mounting structure according to claim 1, wherein:
the compartment cover is connected to the locking mechanism in a linkage manner, and
when the compartment cover moves from the first position to the second position, a position of the locking mechanism is changed to unlock the battery pack.

3. The battery pack mounting structure according to claim 2, wherein:
when the compartment cover is in the first position, the locking mechanism locks the battery pack, and
the locking mechanism comprises:
a main locking member including a locking position for locking the battery pack in the accommodation cavity and an unlocking position for releasing the battery pack in the accommodation cavity; and
a linkage assembly connected to the compartment cover and configured to act on the main locking member,
wherein when the compartment cover moves from the first position to the second position, the linkage assembly drives the main locking member to move from the locking position to the unlocking position.

4. The battery pack mounting structure according to claim 3, wherein:
the compartment cover is pivotally connected to the mounting body and configured to rotate around an axis of a pivot shaft to the first position and the second position respectively, and
the linkage assembly comprises:
an actuating member connected to the compartment cover to rotate synchronously around the axis of the pivot shaft; and
a moving member abutting against the actuating member and configured to act on the main locking member,
wherein when the compartment cover rotates from the first position to the second position, the actuating member pushes against the moving member, and the moving member drives the main locking member to move from the locking position to the unlocking position.

5. The battery pack mounting structure according to claim 4, wherein:
the actuating member is a pawl or a cam, and the moving member is a push rod; or
the actuating member is a gear, and the moving member is a rack.

6. The battery pack mounting structure according to claim 4, wherein:
the pivot shaft is connected to the compartment cover to rotate synchronously around an axis of the pivot shaft, and
the actuating member is actively disposed at the pivot shaft.

7. The battery pack mounting structure according to claim 4, wherein:
the linkage assembly is provided with a guiding portion,
the main locking member is connected to the moving member through the guiding portion,
the guiding portion is configured to guide the main locking member to move along a preset path,
the locking position and the unlocking position are both located on the preset path,
the guiding portion comprises a first guiding inclined surface and a second guiding inclined surface abutting against each other,
the first guiding inclined surface is disposed on the main locking member, and
the second guiding inclined surface is disposed on the moving member.

8. The battery pack mounting structure according to claim 3, wherein:
the battery pack mounting structure further comprises a reset assembly configured to move the main locking member from the unlocking position to the locking position when the compartment cover changes from the second position to the first position; and
the reset assembly comprises:
a base disposed on the mounting body, the main locking member being movably mounted in the base; and
a first elastic member including one end pushing against the base and another end pushing against the main locking member,
wherein when the compartment cover moves from the second position to the first position, the main locking member moves from the unlocking position to the locking position under action of the first elastic member.

9. The battery pack mounting structure according to claim 1, wherein:
the compartment cover comprises a grip portion for an operator to grip and open the compartment cover, and
the battery pack mounting structure further comprises an unlocking member configured to trigger the locking mechanism to unlock the battery pack,
wherein a distance between the unlocking member and the grip portion is configured to allow an operator to apply an external force to the unlocking member while opening the compartment cover with one hand, so as to achieve opening the compartment cover and unlocking the battery pack with one hand by the operator.

10. An electric device comprising:
a battery pack mounting structure including:
a mounting body configured to support a battery pack;
a locking mechanism configured to lock the battery pack to maintain the battery pack at an installation position, or release the battery pack to allow the battery pack to detach from the installation position; and
an anti-detachment assembly configured to prevent the battery pack from detaching from the installation position when the electric device is turned from a horizontal state to a vertical state.

11. The electric device according to claim 10, wherein the anti-detachment assembly comprises:
an auxiliary locking member configured to switch between an unlocking position for releasing the battery pack and a locking position for locking the battery pack; and
a retaining member configured to prevent the auxiliary locking member from displacing from the locking position of the auxiliary locking member to the unlocking position of the auxiliary locking member when the electric device is turned from the horizontal state to the vertical state.

12. The electric device according to claim 11, wherein:
when the electric device is in the vertical state, the retaining member is coupled to the auxiliary locking member to prevent the auxiliary locking member from displacing from the locking position of the auxiliary locking member to the unlocking position of the auxiliary locking member; and
when the electric device is in the horizontal state, the retaining member is disengaged from the auxiliary locking member, and the auxiliary locking member is free to switch between the locking position of the auxiliary locking member and the unlocking position of the auxiliary locking member.

13. The electric device according to claim 11, wherein:
when the electric device is in the vertical state, the retaining member is coupled to the auxiliary locking member by gravity, and
when the electric device is in the horizontal state, the retaining member is disengaged from the auxiliary locking member by gravity.

14. The electric device according to claim 10, wherein the battery pack mounting structure further comprises a compartment cover movably mounted on the mounting body and configured to cooperate with the mounting body to form an accommodation cavity for accommodating the battery pack, the compartment cover including a first position where the compartment cover cooperates with the mounting body to close the accommodation cavity, and a second position where the compartment cover is opened to allow access to the battery pack,
wherein movement of the compartment cover from the first position to the second position is configured to trigger a position change of the locking mechanism to unlock the battery pack.

15. The electric device according to claim 14, wherein:
the compartment cover is connected to the locking mechanism in a linkage manner,
when the compartment cover moves from the first position to the second position, the compartment cover drives the locking mechanism to change position to unlock the battery pack;
the locking mechanism comprises: a main locking member and a linkage assembly;
the main locking member includes a locking position for locking the battery pack in the accommodation cavity and an unlocking position for releasing the battery pack in the accommodation cavity; and
the linkage assembly is connected to the compartment cover and configured to act on the main locking member,
wherein when the compartment cover moves from the first position to the second position, the linkage assembly drives the main locking member to move from the locking position of the main locking member to the unlocking position of the main locking member.

16. The electric device according to claim 14, wherein:
the electric device includes an opening for accessing the battery pack by opening the compartment cover, and
when the electric device is in the vertical state, the opening faces a ground.

17. The electric device according to claim 11, wherein when the locking mechanism unlocks the battery pack and the electric device is in the vertical state, the retaining member prevents the auxiliary locking member from displacing from the locking position of the auxiliary locking member to the unlocking position of the auxiliary locking member.

18. A method for removing a battery pack from a battery pack mounting structure, the method comprising:
opening a compartment cover of the battery pack mounting structure, the battery pack mounting structure including:
a mounting body configured to support a battery pack;
a compartment cover movably mounted at the mounting body and configured to cooperate with the mounting body to form an accommodation cavity for accommodating the battery pack, the compartment cover including a first position where the compartment cover cooperates with the mounting body to close the accommodation cavity and a second position where the compartment cover is opened to allow access to the battery pack; and
a locking mechanism configured to lock or unlock the battery pack,
wherein movement of the compartment cover from the first position to the second position is configured to trigger a position change of the locking mechanism to unlock the battery pack;
in response to a movement of the compartment cover from a first position to a second position, triggering the locking mechanism to unlock the battery pack; and
removing the battery pack located in the accommodation cavity of the battery pack mounting structure.
